(19) United States
(12) Patent Application Publication
(10) Pub. No.: US 2010/0121906 A1
(43) Pub. Date: May 13, 2010

(54) DEVICE MANAGEMENT APPARATUS AND METHOD FOR HOME NETWORK SYSTEM

(75) Inventors: Tai-yeon KU, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/614,871

(22) Filed: Nov. 9, 2009

(30) Foreign Application Priority Data
Nov. 11, 2008 (KR) 10-2008-0111804
May 22, 2009 (KR) 10-2009-0044867

(51) Int. Cl. G06F 15/177; G06F 9/44; G06F 15/16; G06F 17/00

(52) U.S. Cl. 709/202; 709/221; 717/173; 709/224; 700/90; 713/2

(57) ABSTRACT

A device management apparatus for a home network system includes: a local device manager for controlling and managing device initialization, software maintenance, device status monitoring and device event alarm management for adaptive middleware devices in the home network system; and a local device agent for performing device initialization, software maintenance, device status monitoring and device event alarm management for each adoptive middleware device under control and management of the local device manager. The local device manager provides a Universal Middleware Bridge (UMB) device to the adaptive middleware device or application service in a form of a Virtual Device Type (VDT) device.

### CROSS-REFERENCE(S) TO RELATED APPLICATION

The present invention claims priority of Korean Patent Application No. 10-2008-0111804, filed on Nov. 11, 2008 and Korean Patent Application No. 10-2009-0044867, filed on May 22, 2009 which are incorporated herein by reference.

### FIELD OF THE INVENTION

The present invention relates, to management techniques for respective high end devices in a home network system, and, more particularly, to a device management apparatus and method suitable for managing the respective high end devices used in the home network system.

### BACKGROUND OF THE INVENTION

As is well known to those skilled in the art, initial home networking merely belonged to home automation or a home control system which is capable of automatically controlling security, lighting, temperature and the like in a house.

However, as personnel computers (PCs) and peripheral devices have propagated to each house, networking technologies for efficiently connecting the PCs and the devices to each other have introduced. Further, as home networking kits supporting such networking technologies appear, the concept of home networking has started to be used in earnest.

Moreover, with the development of transmission media techniques that are improved over existing telephone lines, power lines or wireless schemes, and with the realization of wideband subscriber networks such as a Digital Subscriber Line (DSL) and a cable modem, ultra-fast Internet has been rapidly popularized. Further, as various types of high end digital information terminals as well as PCs have been introduced to each house.

Meanwhile, in order to manage the high end devices existing in a house (e.g., a notebook computer, a PC, a digital TV and the like), a user personally sets various types of management conditions for the high end devices through host management functions provided by Operating Systems (OSs) (e.g., a Windows system or the like) installed in the devices.

However, in the conventional home network system which has the high end devices therein does not provide periodical management and automatic configuration for the devices in its home network middleware.

### SUMMARY OF THE INVENTION

Therefore, the present invention provides a device management apparatus and method for a home network system, which are capable of performing device recognition, information collection and device management for high end devices.

The present invention further provides the device management apparatus and method for a home network system, which are capable of performing device initialization, software update, real-time monitoring and event notification for high end devices.

In accordance with a first aspect of the present invention, there is provided a device management apparatus for a home network system. The apparatus includes: a local device manager for controlling and managing device initialization, software maintenance, device status monitoring and device event alarm management for adaptive middleware devices in home network system; and a local device agent for performing device initialization, software maintenance, device status monitoring and device event alarm management for each adoptive middleware device under control and management of the local device manager.

In accordance with a second aspect of the present invention, there is provided a device management method for a home network system. The method includes: booting a home device according to a preset booting procedure and then driving a local device agent; setting a network address through the driven local device agent; searching for a local device manager corresponding to the home device through the local device agent; and transmitting device information of the home device to the searched local device manager.

In accordance with a third aspect of the present invention, there is provided a device management method for a home network system. The method includes: when installation or update of software of the home device has been requested, downloading and storing the software for a home device; checking whether a service using the home device is being performed; if the service using the home device is being performed, moving the service to another home device; and installing or updating the software in the home device.

In accordance with a fourth aspect of the present invention, there is provided a device management method for a home network system. The method includes: receiving a request for controlling or monitoring a home device from a device manager; generating a Virtual Device Type (VDT)-based device table by a local device manager in response to the received request for controlling or monitoring the home device; converting a control or monitoring message for adaptive middleware into a Universal Middleware Bridge (UMB) message by using the generated VDT-based device table; and transferring the UMB message to a local device agent corresponding to the home device.

In accordance with a fifth aspect of the present invention, there is provided a device management method for a home network system. The method includes: receiving a request for registration of an event for a home device from a device manager; registering the requested event by a local device manager in response to the request for registration of the event for the home device; notifying a local device agent corresponding to the home device of the registered event; determining whether an event has occurred in the home device through the local device agent; and when the event has occurred, notifying an adaptive middleware component or application service, which has registered the event, of occurrence of the event.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing a home network management system for managing a variety of devices in a home network in accordance with the embodiments of the present invention;

FIG. 2 is a block diagram showing a device management apparatus for performing home networking in accordance with the embodiments of the present invention;

FIG. 3 is a diagram showing the types of home devices in a house in accordance with the embodiments of the present invention;

FIG. 4 is a flowchart showing a process for initializing a home device by using a device management apparatus in accordance with a first embodiment of the present invention;

FIG. 5 is a flowchart showing a process for installing or updating software for the home device in accordance with a second embodiment of the present invention;

FIG. 6 is a flowchart showing a process for removing software installed in a home device according to in accordance with a third embodiment of the present invention;

FIG. 7 is a flowchart showing a process for monitoring a status of a home device in accordance with a fourth embodiment of the present invention; and

FIG. 8 is a flowchart showing a process for managing an event alarm of a home device in accordance with a fifth embodiment of the present invention.

### DETAILED DESCRIPTION OF THE EMBODIMENTS

Hereinafter, embodiments of the present invention will be described in detail with reference to the accompanying drawings which form a part hereof.

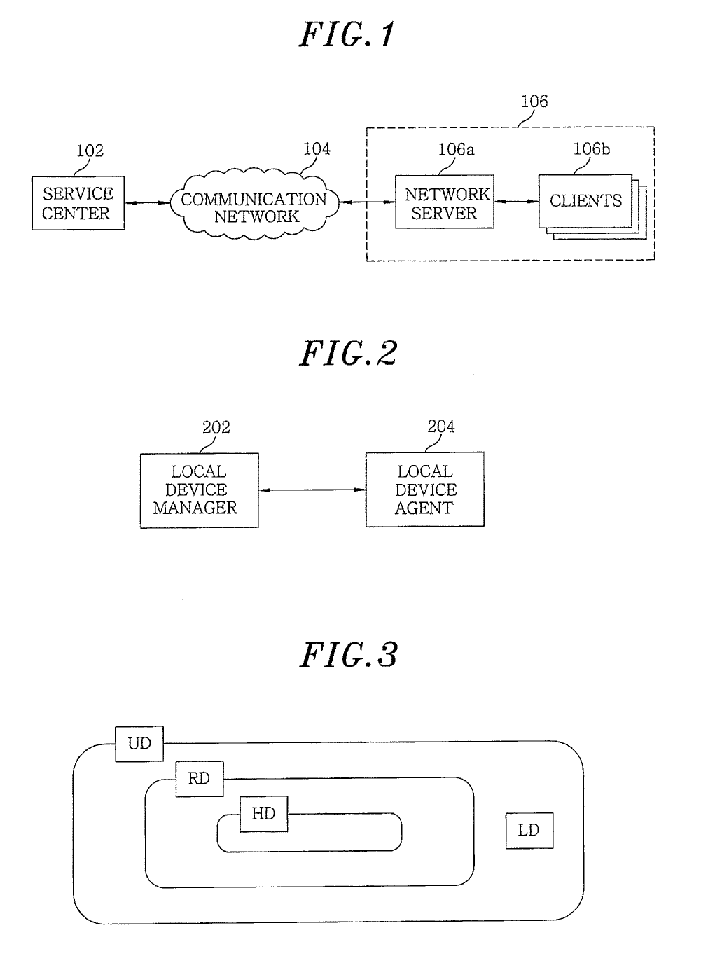

FIG. 1 is a block diagram showing a home network management system for managing a variety of high end devices in a home network in accordance with the embodiments of the present invention. The home network management system includes a service center 102, a communication network 104 and a home network system 106. The home network system 106 includes a network server 106a and clients 106b.

Referring to FIG. 1, the service center 102 includes, e.g., a service server of device manufacturer and the like, and provides download services of software and firmware for the variety of high end devices in the home network system 106.

Further, the communication network 104 denotes a wired/wireless communication network, and takes charge of data communication between the service center 102 and the home network system 106 through various wired/wireless communication modules (not shown).

Next, the home network system 106 includes the network server 106a for performing various types of networking through the communication network 104, and the clients 106b connected to the network server 106a. The network server 106a manages various types of data transmitted from the service center 102 through the communication network 104, wherein the data is provided to the clients 106b as needed. Further, the network server 106a performs the functions of providing an error prediction service, a multimedia data transmission service, a multicasting service and the like.

Further, the clients 106b are home devices which are included in the home network system 106 to perform home networking. FIG. 3 is a diagram showing the types of home devices in accordance with the embodiments of the present invention. The home devices refer to all physical devices (ubiquitous home devices: UDs) present in the home network system 106 and connected through the home network. It can be seen that the UDs are classified into devices, legacy devices: LDs, recognized through home network middleware and devices, rubiham devices: RDs, each equipped with the local device agent 204. The RDs include host devices (HDs) for implementing adaptive middleware services and components.

Each of the clients 106b performs an error prediction service, a multimedia data transmission service, a multicasting service and the like provided by the network server 106a, through the variety of devices. Further, each of the clients 106b includes a device management apparatus which provides a device initialization service such as system information initialization, Local Device Manager (LDM) discovery and device recognition, a software maintenance service such as software downloading, software installation and update and software removal, a device status monitoring service and a device event alarm management service, under the control of the network server 106a.

Next, a device management apparatus, included in each of the clients 106b, will be described in detail with reference to FIG. 2.

FIG. 2 is a block diagram showing a device management apparatus for performing home networking in accordance with the embodiments of the present invention. The device management apparatus include a local device manager 202 and a local device agent 204.

The local device manager 202 performs management functions depending on home device environments configured in each of the clients 106b. That is, the local device manager 202 controls its corresponding client depending on condition information of the home device environments configured in the client 106b. More specifically, the local device manager 202 performs control and management functions, such as device initialization, software maintenance, device status monitoring, and device event alarm monitoring for adaptive middleware devices among the clients 106b.

Further, the local device manager 202 shows a universal middleware bridge (hereinafter referred to as ‘UMB’) device to adaptive middleware components or application services in a form of a virtual device type (hereinafter referred to as ‘VDT’), supports the function of controlling or monitoring the device based on actions described in VDT, and provides a function of allowing the adaptive middleware components or application services to receive the event of the UMB device through an event handler.

The local device agent 204 performs functions of the device initialization for initializing home devices (the high end devices) when the home devices derived, the software maintenance such as firmware required to drive the home devices, the device status monitoring for detecting variation in the execution status of the home devices, and the device event alarm management for providing an alarm in case of an error message or event generated in each home device itself.

The device initialization function is described as follows. After the home devices have been initialized according to the booting sequence preset for the respective home devices, procedures such as recognition of a local device agent 204, the network setting, and the recognition of home devices are performed. When initialization is performed according to the booting sequence preset for respective home devices, the local device agent 204 is driven. Then, the local device agent 204 recognizes network information and determines whether a network address has been allocated. When network information is not set, the local device agent 204 analyzes an initialization information file and sets a network by using stored IP information. When there is no network information, the local device agent 204 sets a network address through a Dynamic Host Configuration Protocol (DHCP) server.

Further, when the setting of the network address has been completed, the local device agent 204 registers itself in the local device manager 202 to participate in adaptive middleware. The local device agent 204 searches for the local device manager 202 by using a discovery protocol, and thus the local device manager 202 sends a response to the local device agent 204. When this procedure has been completed, the local device agent 204 transmits home device information to the local device manager 202 by using a communication protocol between the local device manager 202 and the local device agent 204. When this searching has failed, the local device agent 204 may recognize that a local device manager 202 is not present, and may determine whether or not the local device manager 202 has been executed by determining whether the execution file of the local device manager included in preset path information is present.

Further, the device software maintenance function is described as follows. Software for home devices is classified into firmware required to drive devices and libraries required to implement device functions. If the initialization of the home devices has been completed, firmware information and library information are collected, a firmware list and a library list corresponding thereto are generated, and the software status information of the home devices is organized based on the lists, and thus a status information table including the status information is generated and maintained. When the update, removal or installation of software is performed, information related thereto is applied to and managed in the status information table. The maintenance of software may be performed through procedures such as downloading, installation/update, and removal.

Following is a description in which the above-described device management apparatus initializes system information, discovers a local device manager, and recognizes a variety of home devices.

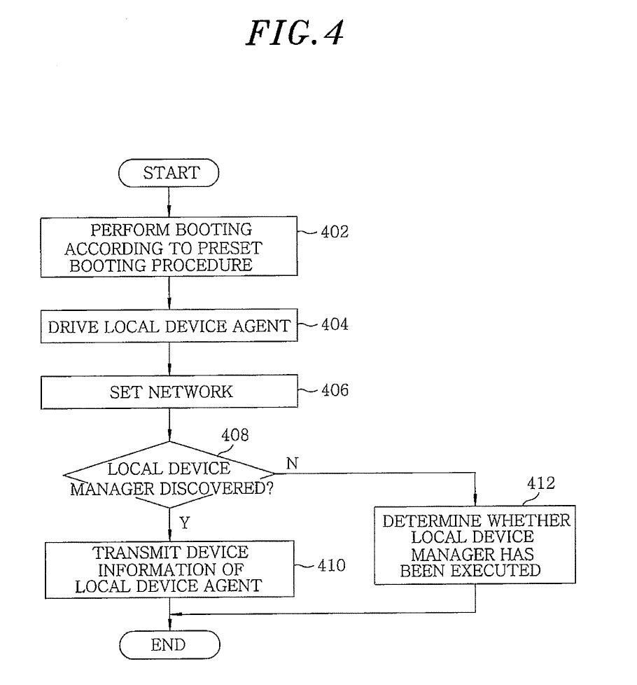

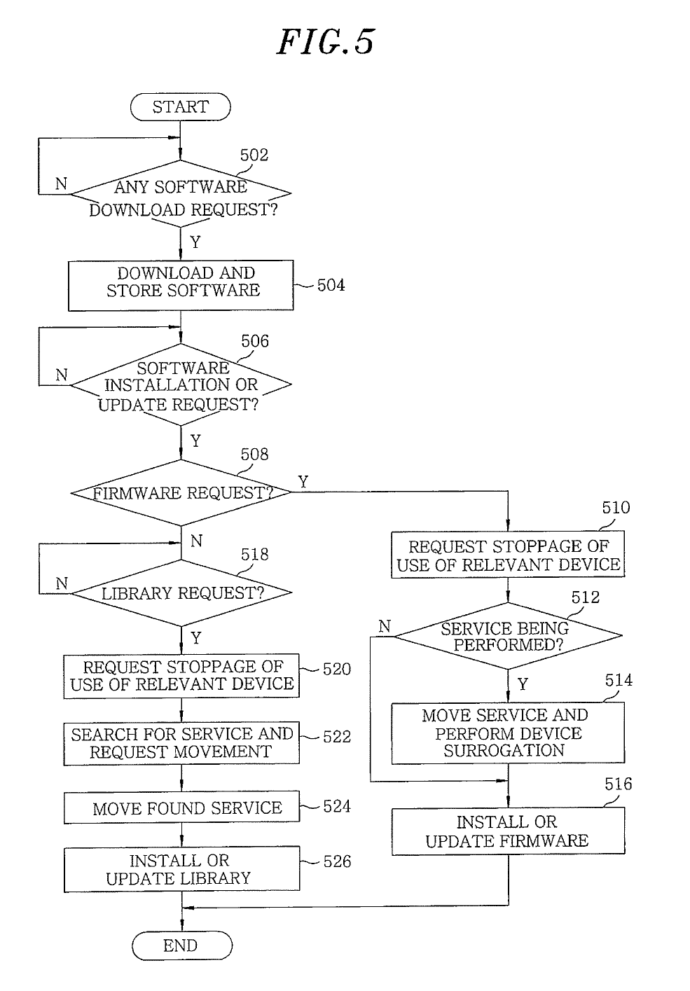

FIG. 4 is a flowchart showing a process for initializing a home device at a home device initialization mode in accordance with a first embodiment of the present invention.

Referring to FIG. 4, in home device initialization mode of the device management apparatus, booting is performed according to a booting procedure preset for respective home devices at step 402 and the local device agent 204 is driven at step 404.

Further, the local device agent 204 recognizes network information and determines whether a network address has been allocated. If it is determined that network information has not been set, the local device agent 204 analyzes a file in which initialization information is described, sets a network using stored IP information, and sets the network through a DHCP server when initialization information is not present at step 406. Therefore, in order to maintain IP information even in subsequent execution, network setting may be maintained by revising and storing the file in which initialization information is described when the IP information changes.

Next, the local device agent 204 searches for the local device manager 202 by using a discovery protocol, and determines whether the local device manager 202 has been discovered at step 408. In this case, the local device manager 202 transmits a response message corresponding to the discovery procedure performed by the local device agent 204, thus enabling the local device agent 204 to discover the local device manager 202.

If it is determined at step 408 that the local device manager 202 has been discovered, the local device agent 204 transmits device information to the local device manager 202 through a communication protocol at step 410.

In contrast, if it is determined at step 408 that the local device manager 202 has not been discovered, the local device agent 204 recognizes that the local device manager 202 is not present, and determines whether the local device manager 202 has been executed at step 412. In this case, the determination of whether the local device manager 202 has been executed may be performed by determining whether there is the execution file of the local device manager 202 included in the preset path.

Therefore, as described above system information is initialized by using the device management apparatus, the local device manager is discovered, and thereafter a variety of home devices can be effectively recognized.

Next, a process for installation or update for software a home device is performed after the initialization and recognition of the home devices.

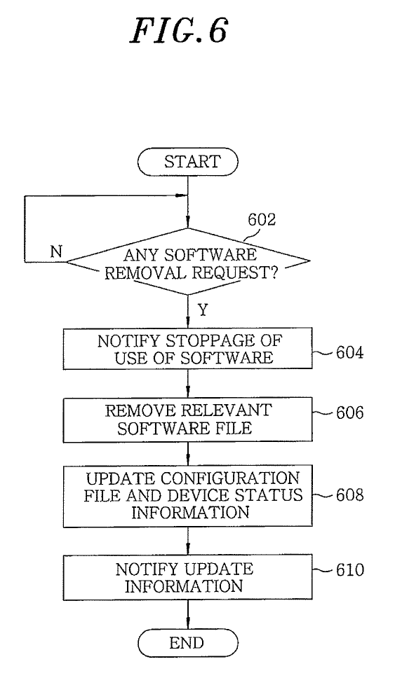

FIG. 5 is a flowchart showing a process for installing or updating software for the home device at a software maintenance mode in accordance with a second embodiment of the present invention.

In order to maintain home devices, software used in the home devices is needed to be managed. Software related to the home devices includes Firmware for driving the home devices, Lib for realizing device functions. After the initialization of the home device, information of Firmware and Lib is collected to make a list. By using the list, software status information of the current home devices is collected and the information is managed in a table. Further, when the software is updated, deleted or installed, the information is used to maintain latest information all the time. In the local device agent 204, the maintaining procedure includes: download, installation/update and removal.

Referring to FIG. 5, in a software maintenance mode of the device management apparatus, the local device manager 202 determines whether downloading of software corresponding to a specific home device has been requested at step 502.

If it is determined at step 502 that downloading of software has been requested, the local device manager 202 commands to the local device agent 204 to request downloading of the relevant software from the service center 102, connected to the communication network 104 through the network server 106a, and then store the software received from the service center 102 through the network server 106a at step 504. In this case, the local device manager 202 may access the service center 102 by using information on download paths for each home device provided by the local device agent 204, thereby taking various types of software download services, and continuously updating software information stored at the download path on the basis of the software download services.

Next, the local device manager 202 determines whether the installation or update of software for the specific home device has been requested at step 506.

If it is determined at step 506 that the installation or update of software has been requested, the local device manager 202 determines whether the request for the installation or update of the software is a request for firmware at step 508.

If it is determined at step 508 that the request for the installation or update of software at step 506 is the request for firmware, the local device manager 202 requests the network server 106a to stop using the relevant home device in which the firmware is to be installed or updated at step 510.

Accordingly, the network server 106a determines whether a service using the relevant home device is being performed at step 512.

If it is determined at step 512 that the service is being performed, the Software Manager (SM) of the network server 106a moves the service, and the network server 106a performs device surrogation for the service if the service is bound at step 516. In this case, device surrogation is performed when a home device performing the same function is present, whereas the network server 106a provides notification of a binding error when a home device performing the same function is not present.

Further, the local device manager 202 installs or updates the firmware in the relevant home device through the local device agent 204 at step 516. Of course, if it is determined at step S512 that a service is not being performed, the procedure for installing or updating the firmware is directly performed at step 516.

Meanwhile, if it is determined at step 508 that the request for installation or update of software at step 506 is not the request for firmware, the local device manager 202 determines whether the request for the installation or update of software a request for a library at step 518.

If it is determined at step 518 that the request for installation or update is a request for a library, the local device manager 202 requests the network server 106a to stop using the relevant home device depending on the installation or update of the library at step 520.

Further, the network server 106a searches for a service operated in a home device which uses the library, and requests the software manager to move the found service at step 522. The software manager moves the service to another home device which performs the same service at step 524.

Next, the local device manager 202 installs or updates the relevant library in the home device through the local device agent 204 at step 526.

Therefore, as described above when a request for the installation or update of software is received, the device management apparatus downloads and stores relevant software and thereafter effectively installs or updates the software corresponding to firmware or a library in a corresponding home device.

Hereinafter, removing a software file upon a request for the removal of software received in the software maintenance mode will be described.

FIG. 6 is a flowchart showing a process for removing software installed in a home device in accordance with a third embodiment of the present invention.

Referring to FIG. 6, in the software maintenance mode of the device management apparatus, the local device manager 202 determines whether a request for the removal of software has been received at step 602.

If it is determined at step 602 that the software removal request has been received, the local device manager 202 notifies the network server 106 of the stop request of the use of the corresponding software at step 604.

Then, the local device manager 202 removes a software file corresponding to the software at step 606.

Next, the local device manager 202 updates a configuration file and device status information at step 608, and thereafter notifies a device manager in the network server 106a of such update information at step 610.

Therefore, as described above, when a request for the removal of software is received, the device management apparatus stops the use of the software, removes a software file corresponding to the software, and updates a configuration file and device status information, thus effectively removing the software that is requested to be removed.

Next, a process for controlling and monitoring a home device by using the device management apparatus having the above-described configuration will be described.

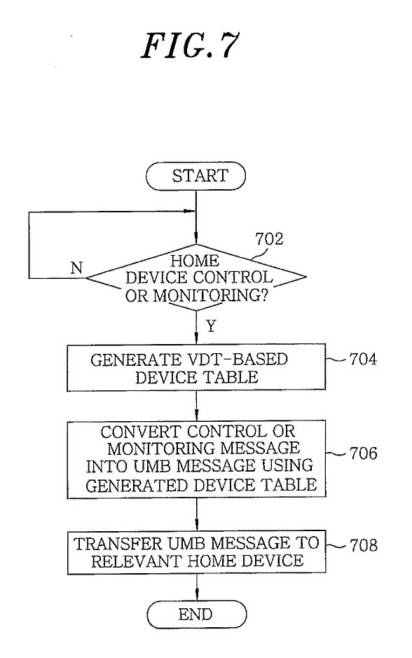

FIG. 7 is a flowchart showing a process for monitoring a status of a home device in accordance with a fourth embodiment of the present invention.

Referring to FIG. 7, in device status monitoring mode of the device management apparatus, the local device manager 202 determines whether a request for the control or monitoring of a home device has been received from the device manager of the network server 106a at step 702.

If it is determined at step 702 that the request for the control or monitoring of the home device has been received, the local device manager 202 generates a VDT-based device table at step 704.

Further, the local device manager 202 converts a control or monitoring message for adaptive middleware into a UMB message by using the generated VDT-based device table at step 706, and transmits the UMB message to the local device agent 204, thereby enabling the UMB message to be transferred to the relevant home device at step 708.

Therefore, the function of controlling or monitoring a variety of home devices can be effectively performed by using the device management apparatus.

Next, a process in which adaptive middleware components or application services are provided with the event of a UMB device by using an event handler in the device management apparatus having the above-described configuration is described below.

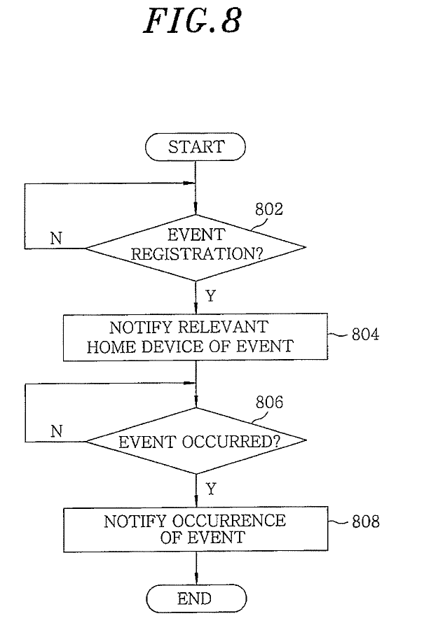

FIG. 8 is a flowchart showing a process for managing an event alarm of a home device in accordance with a fifth embodiment of the present invention.

Referring to FIG. 8, in the device event and alarm management mode of the device management apparatus at step 800, the local device manager 202 determines whether a request for the registration of an event for a UMB device has been received from the device manager of the network server 106a at step 802.

If it is determined at step 802 that the request for the event registration for the UMB device has been received, the local device manager 202 registers the requested event, and notifies the relevant home device of the registered event through the local device agent 204 at step 804.

Further, the local device manager 202 determines whether an event has occurred in the home device through the local device agent 204 at step 806.

If it is determined at step 806 that an event has occurred, the local device manager 202 notifies a relevant adaptive middleware component or application service, which has registered the event, of the occurrence of the event at step 808. Such an event alarm function may be performed through a device event handler, and information required for the registration and transmission of a device event may be stored in an event table.

Therefore, through the use of the device management apparatus, events for home devices are registered and notification of the occurrence of events is provided when events occur, thus enabling the function of managing events for home devices to be provided.

As described above, the present invention is advantageous in that a relevant home device is selected and controlled based on condition information corresponding to respective home device environments, so that various control and management functions such as device initialization, software maintenance, device status monitoring and device event alarm management for respective adaptive middleware devices in clients may be performed, thus enabling a variety of home devices in the home network environment to be effectively managed.

While the invention has been shown and described with respect to the preferred embodiments, it will be understood by those skilled in the art that various changes and modifications may be made without departing from the spirit and scope of the invention as defined in the following claims.

What is claimed is:

1. A device management apparatus for a home network system, comprising:
a local device manager for controlling and managing device initialization, software maintenance, device status monitoring and device event alarm management for adaptive middleware devices in home network system; and
a local device agent for performing device initialization, software maintenance, device status monitoring and device event alarm management for each adoptive middleware device under control and management of the local device manager.

2. The apparatus of claim 1, wherein the local device manager provides a Universal Middleware Bridge (UMB) device to the adaptive middleware device or application service in a form of a Virtual Device Type (VDT) device.

3. The apparatus of claim 1, wherein the local device agent performs the device initialization in such a way to initialize the home devices according to a preset booting sequence when booting the home devices, set a network for each of the home devices, recognize the local device manager corresponding to the set network, and thereafter transmit information of the home device to the local device manager.

4. The apparatus of claim 3, wherein the local device agent determines whether a network address has been allocated to the home device, and analyzes an initialization information file and sets the network based on stored Internet Protocol (IP) information if it is determined that network information has not been set.

5. The apparatus of claim 4, wherein the local device agent sets the network address for the home device through a Dynamic Host Configuration Protocol (DHCP) server when the network information is not present.

6. The apparatus of claim 1, wherein the local device agent performs the software maintenance such as software downloading, software installation and update, and software removal for the home devices.

7. The apparatus of claim 6, wherein the local device agent is configured so that, when initialization of the home devices has been completed, the local device agent collects information of firmware and libraries, generates a firmware list and a library list corresponding to the firmware and library information, collects software status information of the home devices through the lists, and generates and maintains a software information table including the collected software status information.

8. A device management method for a home network system, comprising:
booting a home device according to a preset booting procedure and then driving a local device agent;
setting a network address through the driven local device agent;
searching for a local device manager corresponding to the home device through the local device agent; and
transmitting device information of the home device to the searched local device manager.

9. The method of claim 8, wherein said setting the network address is performed to determine whether the network address has been allocated to the home device, and to analyze an initialization information file and set a network based on stored Internet Protocol (IP) information if it is determined that network information has not been set.

10. The method of claim 9, wherein said setting the network address is performed to set the network address for the home device through a Dynamic Host Configuration Protocol (DHCP) server when the network information is not present.

11. A device management method for a home network system, comprising:
when installation or update of software of the home device has been requested, downloading and storing the software for a home device;
checking whether a service using the home device is being performed;
if the service using the home device is being performed, moving the service to another home device; and
installing or updating the software in the home device.

12. The method of claim 11, wherein said downloading the software is performed so that a local device manager downloads the software by using download path information which corresponds to the home device and is provided by a local device agent.

13. The device management method of claim 11, wherein said moving the service to another home device is performed to move the service when the home device and the another device provide an identical service.

14. A device management method for a home network system, comprising:
receiving a request for controlling or monitoring a home device from a device manager;
generating a Virtual Device Type (VDT)-based device table by a local device manager in response to the received request for controlling or monitoring the home device;
converting a control or monitoring message for adaptive middleware into a Universal Middleware Bridge (UMB) message by using the generated VDT-based device table; and
transferring the UMB message to a local device agent corresponding to the home device.

15. A device management method for a home network system, comprising:
receiving a request for registration of an event for a home device from a device manager;
registering the requested event by a local device manager in response to the request for registration of the event for the home device;
notifying a local device agent corresponding to the home device of the registered event;
determining whether an event has occurred in the home device through the local device agent; and
when the event has occurred, notifying an adaptive middleware component or application service, which has registered the event, of occurrence of the event.

16. The device management method of claim 15, wherein said determining whether an event has occurred is performed through a device event handler in the local device manager.
